(19) United States
(12) Patent Application Publication
(10) Pub. No.: US 2018/0194108 A1
(43) Pub. Date: Jul. 12, 2018

(54) METHOD FOR MANUFACTURING A SHIELDING PART COMPRISING AT LEAST ONE METAL SHIELDING LAYER AND A TEXTILE INSULATING LAYER, AND A SHIELDING PART

(71) Applicant: ElringKlinger AG, Dettingen-Erms (DE)

(72) Inventors: Arne Schönefeld, Degersheim (CH); Silvio Koch, Weite (CH)

(21) Appl. No.: 15/741,616

(22) PCT Filed: Jun. 21, 2016
(86) PCT No.: PCT/EP2016/064235

§ 371 Date: Jan. 3, 2018

(30) Foreign Application Priority Data
Jul. 3, 2015 (DE) 10 2015 110 791.0

(51) Int. Cl. B32B 7/08; B32B 5/08; B32B 15/14; B32B 15/18; B32B 15/20

(52) U.S. Cl. CPC B32B 7/08; B32B 5/08; B32B 15/14; B32B 15/18; B32B 15/20; B32B 2605/08; B32B 2262/101; B32B 2262/02; B32B 2262/0253; B32B 2262/0292; B32B 2250/02

(57) ABSTRACT

A method for manufacturing a shielding part comprising at least one metal shielding layer and a textile insulating layer, said method at least comprising steps a) providing a metal shielding layer and a textile insulating layer, and b) joining the textile insulating layer to the shielding layer using at least one punched rivet connection.

### FIELD OF THE INVENTION

The invention relates to a method for manufacturing a shielding part, which comprises at least one metallic shielding layer and a textile insulating layer, and a shielding part, in particular one that is produced with the method according to the invention.

### BACKGROUND OF THE INVENTION

Particularly with textile underbody panels in automotive engineering, shielding parts are known from the prior art, which have a metallic shielding layer and a textile insulating layer that can also function as a support layer. According to the prior art, these two layers are either glued together over an expansive area or they are attached to each other at various points by means of a multitude of blind rivets or staples.

With thin metallic shielding layers such as stainless steel sheets less than 0.15 mm thick, the textile layer can be glued to the shielding layer in the non-deformed, i.e. usually flat, state and this composite is then brought into its final three-dimensional spatial form by means of forming. With a sheet thickness of the shielding layer of 0.2 mm and more, this method no longer works or only works to a very limited degree.

Usually such connections between thicker metallic layers of this kind and the textile insulating layer are produced by means of blind rivets. In this case, before a forming process or during the forming process, the sheet metal layer and insulating layer or support layer are perforated. After the forming, the textile insulating layer/support layer is attached by means of blind rivets inserted through the holes of the metallic shielding layer. Such a manufacturing process is time-consuming and cost-intensive since it requires at least one perforating tool, which produces the perforation.

The object of the invention is to disclose a method for manufacturing a shielding part comprising at least one metallic shielding layer and a textile insulating layer that can also function as a support layer, which method is inexpensive and easy to perform and also permits the use of metallic shielding layers with a material thickness of more than 0.2 mm, the latter being particularly composed of stainless steel.

Another object of the invention is to disclose a shielding part, which is simple and inexpensive to produce.

### SUMMARY OF THE INVENTION

The invention is based on the realization that—contrary to preconceptions in professional circles—a textile insulating layer, which can also be embodied in the form of a dimensionally stable support layer, can be advantageously attached to a metallic shielding layer by means of the joining method of self-piercing riveting. The object is thus attained in that first, a metallic shielding layer and a textile insulating layer or support layer are prepared and the textile insulating layer or textile support layer is attached to the shielding layer by means of at least one self-piercing riveted attachment.

On the one hand, the method according to the invention can be performed by attaching the textile insulating layer to the shielding layer by means of at least one self-piercing riveted attachment in a non-deformed or only partially deformed—e.g. pre-deformed—state of the shielding layer and insulating layer and then forming the composite into its three-dimensional final spatial form by carrying out a forming process in a forming die.

On the other hand, it is possible to use a hot forming process to transform the textile insulating layer into a three-dimensional formed part, which in particular has an inherent dimensional stability and can function as a support element. This three-dimensional formed part, which has been three-dimensionally formed, is attached to a corresponding three-dimensionally formed metallic shielding layer by means of self-piercing riveting.

In order to produce the self-piercing riveted attachment, at least one rivet is suitably shot in from a side of the textile insulating layer so that the rivet forms a flange in the metallic shielding layer and is secured therein, particularly in a form-fitting manner.

In another embodiment, the metallic shielding layer can be a stainless steel, or aluminum sheet, which for example has a material thickness of between 0.2 mm and 0.7 mm, in particular between 0.2 mm and 0.4 mm.

Both a smooth sheet metal and a dimpled sheet metal can be used as the metallic shielding layer.

It has proven worthwhile to use an LWRT fleece, in particular composed of a mixture of thermoplastic fibers and glass fibers, as the textile insulating layer. LWRT materials are based on a fleece material and are a mix of glass fibers with thermoplastic fibers made of polypropylene or polyurethane. LWRT materials (Light Weight Reinforced Thermoplastics can also be multi-layered, for example with a glass fiber core enclosed by thermoplastic fiber layers.

In an advantageous modification of the method according to the invention, the method is carried out with a self-piercing rivet that has a head diameter of more than twice the shaft diameter, in particular more than 2.5 times the shaft diameter. This achieves particularly high pull-out forces.

If the composite of the textile insulating layer and metallic shielding layer is produced in a non-deformed, e.g. flat, state or in a partially preformed state, then it is advantageous that for the forming procedure, the composite is placed into a forming die, which has recesses for accommodating the at least one rivet head or the at least one flange of the self-piercing riveted attachment.

The method according to the invention advantageously enables the composite of the metallic shielding layer and textile insulating layer to be formed without glue and in particular, allows it to be produced without glue. It has surprisingly turned out that only the self-piercing riveting fastening process, in which the self-piercing rivet penetrates the textile insulating layer/support layer, offers a sufficient amount of both a static and dynamic strength.

The invention is also based on the realization that a shielding part is particularly inexpensive and with regard to the strength requirements, is especially sufficient if at least one metallic shielding layer is attached to a textile insulating layer by means of a self-piercing riveted attachment, forming a composite. It has surprisingly turned out that such a composite with the desired properties can be produced without glue and without other fastening or joining means.

A shielding part according to the invention can be advantageously modified in that the textile insulating layer is an LWRT fleece and likewise has a spatial form that has an inherent dimensional stability, i.e. is self-supporting. This makes it possible to only partially attach metallic shielding layers in places that are subject to particular thermal stresses.

A stainless steel, steel, or aluminum sheet can be used for such shielding layers, which has a material thickness of 0.2 mm to 0.7 mm, in particular between 0.2 mm and 0.4 mm. it has surprisingly turned out that a composite of such thin metallic shielding layers and the textile insulating layer made by means of self-piercing riveting is sufficiently strong and resilient. Because of the plastic deformation that occurs in self-piercing riveting, professional circles usually recommend the self-piercing riveting process for metallic sheet thicknesses of 0.75 mm and more, particularly in order to produce a sufficiently strong composite. For the person skilled in the art, it was therefore surprising that—for the application of a shielding part—metallic shielding layers with significantly thinner sheet thicknesses could be reliably attached to a textile support layer by means of self-piercing riveting.

A self-piercing rivet head of a self-piercing rivet is advantageously positioned on the side of the textile insulating layer and a flange of the self-piercing riveted attachment is positioned on the opposite side, on the side of the metallic shielding layer of the composite. If a self-piercing rivet head is used, which has correspondingly large dimensions, particularly with a self-piercing rivet head diameter of more than twice the shaft diameter and particularly preferably with a self-piercing rivet head diameter of more than 2.5 times the shaft diameter, then it is possible to achieve high pull-out-forces and thus a high strength of the self-piercing riveted attachment between the insulating layer and the shielding layer.

### BRIEF DESCRIPTION OF THE DRAWINGS

The invention will be explained in greater detail below by way of example based on the drawings. In the drawings:

FIG. 1: is a very schematic perspective view of an embodiment of a shielding part according to the invention;

FIG. 2: shows a cross-section through a self-piercing riveted attachment of a shielding part according to the invention.

### DETAILED DESCRIPTION OF THE PREFERRED EMBODIMENTS

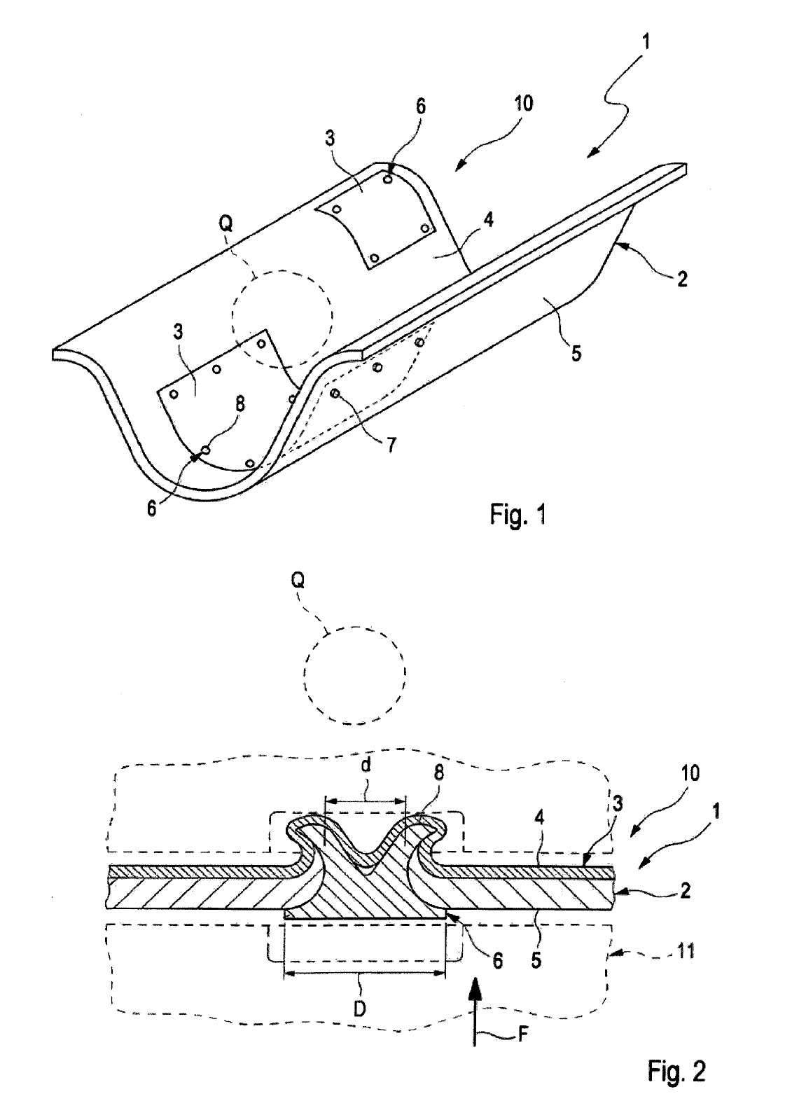

FIG. 1 is a very schematic depiction of one embodiment of the shielding part 1 according to the invention. The shielding part 1 has a textile insulating layer 2 and at least one metallic shielding layer 3. The textile insulating layer 2 has a first side 4 facing a heat source Q and for example a second side 5 facing away from the heat source Q. The metallic shielding layers 3 are fastened in at least some areas on the first side 4 facing the heat source Q, with the fastening being produced by means of self-piercing rivets 6 that are provided for the purpose.

The self-piercing rivets 6 are driven in from the second side 5, through the insulating layer 2 and into the metallic shielding layer 3. As a result, a self-piercing rivet head 7 rests against the textile insulating layer 2. At the end opposite from the self-piercing rivet head 7, a self-piercing riveted connection forms a flange 8, which appears as a bump in the metallic shielding layer 3.

The metallic shielding layer 3 can be a stainless steel, steel, or aluminum sheet or a composite material. The textile insulating layer 2 can, for example, be a preformed LWRT fleece with inherent dimensional stability, which can be embodied as single-layered or multi-layered.

The textile insulating layer 2 is perforated as the self-piercing rivets 6 are being seated. A slug of the pierced layer (in this case the textile insulating layer 2), which is typical for self-piercing riveting, remains in a cavity, for example of a semi-tubular rivet. After the metallic shielding layer 3 and textile insulating layer 2 are attached, this therefore yields a composite 10. The metallic shielding layers 3 are preferably positioned facing a heater or heat source Q, in particular without touching the latter.

FIG. 2 shows a very schematic cross-section through a self-piercing riveted attachment of a shielding part according to the invention 1. In this case, the textile insulating layer 2 is depicted as the lower layer in FIG. 2. The second side 5 is an open top surface of the textile insulating layer 2. In FIG. 2, the metallic shielding layer 3 is shown at the top in the vertical direction. Its first side 4 is an open top surface. A self-piercing rivet 6 is driven along a joining direction IF from the second side 5, passing through the textile insulating layer 2 and penetrating into the metallic shielding layer 3. The flange 8 forms on the open top surface (first side 4 of the metallic shielding layer 3). The heat source Q is schematically depicted in FIG. 2. This heat source Q is oriented toward and spaced apart from the metallic shielding layer 3.

With the method according to the invention and the shielding part according to the invention, it is particularly advantageous that the joining of the shielding layer 3 to the insulating layer 2 does not require any previous perforation of the layers to be carried out and does not require the hole patterns to be brought into superposition, as is the case in a blind riveting procedure.

The shielding part according to the invention and the method according to the invention also make it possible to produce complex three-dimensional geometries of the two layers and to join them to each other. For example, with a glued joining of the layers, this is not so easily possible because a gluing envisages a certain maximum gap dimension and due to tolerances, this cannot always be easily achieved. It has even turned out that a composite that is joined in a flat or slightly preformed state (see FIG. 2) can be formed in a suitable forming die (schematically indicated by the reference numeral 11); the forming die 11 has recesses 12 in which a possibly protruding self-piercing rivet head 7 or flange 8 can be positioned during the shaping process. In this case, it is even possible to join the insulating layer 2 and the shielding layer 3 before the forming and for the forming to be carried out in the joined state.

In particular, a self-piercing rivet head diameter D is twice as great, in particular preferably more than 2.5 times as great, as a shaft diameter d of a rivet shaft in the non-deformed state.

1. A method for manufacturing a shielding part comprising at least one metallic shielding layer and a textile insulating layer, the method comprising:
preparing a metallic shielding layer and a textile insulating layer;
attaching the textile insulating layer to the shielding layer using at least one self-piercing riveted attachment.

2. The method according to claim 1, comprising attaching the textile insulating layer to the shielding layer using at least one self-piercing riveted attachment in a non-deformed or only partially pre-deformed state of the shielding layer and insulating layer and subsequently carrying out a three-dimensional forming of a composite of the textile insulating layer and shielding layer in a forming die, or producing a three-dimensional formed pan from the textile insulating layer in a hot-forming process, and transforming the formed part, together with a corresponding three-dimensionally formed metallic shielding layer, into a composite using self-piercing riveting.

3. The method according to claim 2, wherein in order to produce the self-piercing riveted attachment, at least one self-piercing rivet is shot in from a side of the textile insulating layer.

4. The method according to claim 1, wherein a stainless steel, steel, or aluminum sheet is used as the metallic shielding layer.

5. The method according to claim 1, wherein a smooth or dimpled sheet metal is used as the shielding layer.

6. The method according to claim 1, wherein a material thickness of the shielding layer is between 0.2 mm and 0.7 mm.

7. The method according to claim 1, wherein an LWRT fleece, composed of a mixture of thermoplastic fibers and glass fibers, is used as the textile insulating layer.

8. The method according to claim 1, wherein the at least one self-piercing riveted attachment comprises a rivet having a self-piercing rivet head diameter of more than twice a shaft diameter.

9. The method according to claim 2, wherein before the forming, the composite is placed into a forming die, which has recesses for accommodating at least one rivet head or at least one flange of the self-piercing riveted attachment.

10. The method according to claim 2, wherein the composite is formed without glue.

11. The method according to claim 2, wherein the composite is produced without glue.

12. A shielding part, produced using the method according to claim 1, comprising at least one metallic shielding layer and a textile insulating layer, wherein the textile insulating layer is attached to the at least one metallic shielding layer with a self-piercing riveted attachment, forming a composite.

13. The shielding part according to claim 12, wherein the textile insulating layer is an LWRT fleece composed of a mixture of thermoplastic fibers and glass fibers.

14. The shielding part according to claim 12, wherein the shielding layer is a stainless steel, steel, or aluminum sheet, which has a material thickness of between 0.2 mm and 0.7 mm.

15. The shielding part according to claim 12, wherein a self-piercing rivet head of a self-piercing rivet is positioned on a second side of the textile insulating layer and a flange of the self-piercing riveted attachment is positioned on a first side of the metallic shielding layer of the composite.

16. The shielding part according to claim 12, wherein the at least one self-piercing riveted attachment comprises a rivet having a self-piercing rivet head diameter of more than twice a shaft diameter.

17. The shielding part according to claim 12, wherein the textile insulating layer is a multilayered layer with a glass fiber layer and thermally activated PP or PU fibers.

18. The shielding part according to claim 12, wherein the textile insulating layer has a self-supporting formed part with inherent dimensional stability, to which at least one shielding layer is attached only in some areas.
